(19) United States
(12) Patent Application Publication
(10) Pub. No.: US 2014/0252259 A1
(43) Pub. Date: Sep. 11, 2014

(54) BUTTERFLY VALVE

(71) Applicants: Masayuki Yokoyama, Tokyo (JP); Katsunori Takai, Tokyo (JP); Satoru Hasegawa, Tokyo (JP); Haruo Watanuki, Tokyo (JP)

(72) Inventors: Masayuki Yokoyama, Tokyo (JP); Katsunori Takai, Tokyo (JP); Satoru Hasegawa, Tokyo (JP); Haruo Watanuki, Tokyo (JP)

(73) Assignee: MITSUBISHI ELECTRIC CORPORATION, TOKYO (JP)

(21) Appl. No.: 14/350,423

(22) PCT Filed: Jan. 5, 2012
(86) PCT No.: PCT/JP2012/000037

§ 371 Date: Apr. 8, 2014

(51) Int. Cl. F16K 1/22

(52) U.S. Cl. CPC F16K 1/224
USPC 251/305

(57) ABSTRACT

Bearings 18 and 19 each are formed to have an inside diameter gradually extending toward two ends along an axial direction of a shaft 20 such that the inside diameter of the bearing is smaller at the center portion thereof and is larger at the two ends thereof.

### TECHNICAL FIELD

The present invention relates to a butterfly valve for flow rate control of a high temperature fluid such as an exhaust gas recirculation (EGR) valve that circulates exhaust gas, or a bypass valve.

### BACKGROUND ART

In a conventional butterfly valve, valve shaft holes are formed at two places in a direction orthogonal to an extending direction of a fluid passage of a housing, and two ends of a valve shaft of the butterfly valve are inserted into the valve shaft holes, respectively, and the shaft is rotatably supported by a bearing provided at each of the two ends (for example, see Patent Document 1).

### PRIOR ART DOCUMENTS

### Patent Documents

Patent Document 1: Japanese Patent Application Laid-open No. 2007-32301

### SUMMARY OF THE INVENTION

Problems to be Solved by the Invention

In the butterfly valve having the valve shaft supported by the bearings at the two places as shown in Patent Document 1 described above, there is a problem such that when the housing shape is asymmetric about the valve shaft between the upstream and downstream sides, the housing undergoes thermal expansion that is asymmetric between the upstream and downstream sides by the flow of a high temperature fluid, which causes deviation of coaxiality between the two bearings at the two places, resulting in deterioration of slidability or adhesion between the valve shaft and the bearings.

Moreover, in order to avoid the deterioration of slidability, when a clearance between the valve shaft and the bearings is enlarged, there is a problem such that shaft leakage increases from the fluid passage to the outside of the housing through the clearance. Further, there is also a problem such that seat leakage occurs from the upstream side to the downstream side through the clearance even when the butterfly valve is fully closed.

The present invention is made to solve the foregoing problems, and an object of the invention is to provide a butterfly valve that can suppress the increase of the fluid leakage while avoiding the deterioration of slidability and adhesion on the valve shaft when the deviation of coaxiality between the bearings occurs.

### Means for Solving the Problem

A butterfly valve of the present invention includes: a housing provided with a fluid passage; bearings at two places each provided at opposite positions of the housing interposing the fluid passage; a shaft rotatably held by the bearings at the two places; and a valve that opens and closes the fluid passage by rotating integrally with fixed to the shaft, wherein an inside diameter of the bearing has a shape to gradually extend along an axial direction of the shaft.

### Effect of the Invention

According to the present invention, since it is configured that the inside diameter of the bearing has the shape to gradually extend along the axial direction of the shaft, an increase of fluid leakage can be suppressed while avoiding deterioration of slidability and adhesion on the shaft when deviation of coaxiality between the bearings occurs.

### BRIEF DESCRIPTION OF THE DRAWINGS

FIG. 1 is a cross-sectional view showing a structure of a butterfly valve according to Embodiment 1 of the present invention.

FIG. 2 is a cross-sectional view showing an example of thermal deformation of a housing in Embodiment 1.

FIG. 3 is a diagram for illustrating a shape of a bearing of Embodiment 1.

FIG. 4 is an enlarged cross-sectional view of a spring and its peripheral structure of Embodiment 1.

FIG. 5 is an enlarged cross-sectional view of a power transmission member and its peripheral structure of Embodiment 1.

### BEST MODE FOR CARRYING OUT THE INVENTION

In the following, in order to explain the present invention in more detail, embodiments for carrying out the invention will be described with reference to the accompanying drawings.

### Embodiment 1

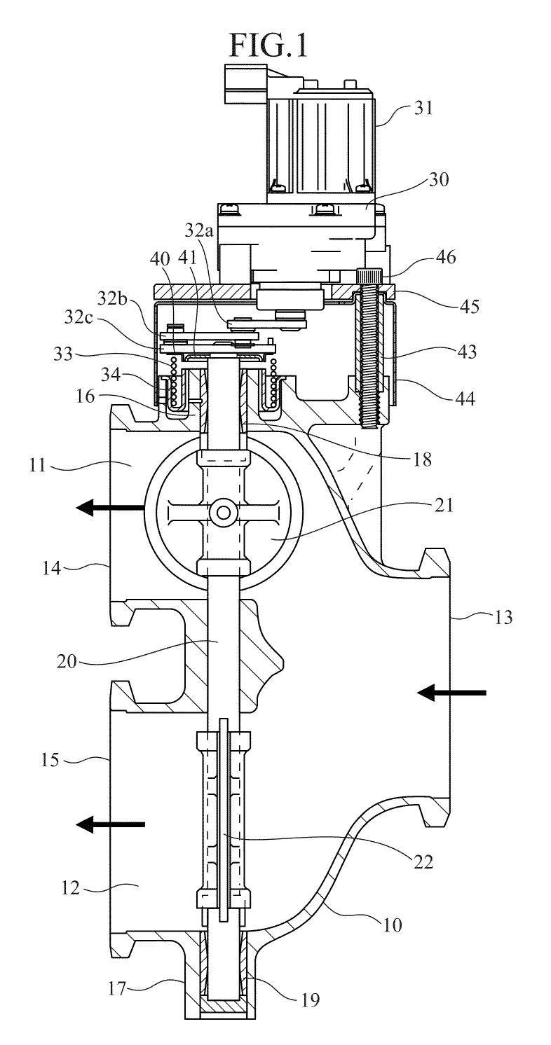

A butterfly valve shown in FIG. 1 includes: a housing 10 interposed between pipes (not shown) through which a fluid is flowed; a shaft 20 rotatably held on the housing 10; and butterfly valves 21 and 22 that open or close fluid passages 11 and 12 with integrally rotated with the shaft 20. The valves 21 and 22 are attached to the shaft 20 at mutually different angles; in the illustrated example, when one valve 21 (or valve 22) opens the fluid passage 11 (or fluid passage 12), the other valve 22 (or valve 21) closes the fluid passage 12 (or fluid passage 11).

The housing 10 is formed with one fluid inlet 13 and two fluid outlets 14 and 15. The fluid passage 11 communicates with the fluid inlet 13 and fluid outlet 14, while the fluid passage 12 communicates with the fluid inlet 13 and fluid outlet 15.

In addition, holes to be penetrated by the shaft 20 are formed in the housing 10. The holes of them at opposite positions between which the fluid passages 11 and 12 are interposed are determined as bearing holding parts 16 and 17. Bearings 18 and 19 that slidably support the shaft 20 are placed in these bearing holding parts 16 and 17, and an opening of the bearing holding part 17 is closed with a cap.

One end of the shaft 20 penetrates the bearing holding part 16 and protrudes to the outside of the housing 10 to be coupled with power transmission members 32a to 32c of an actuator 30. Normal rotation driving force or reverse rotation driving force of a motor 31 is transmitted to the shaft 20 via the power transmission members 32a to 32c, whereby the shaft 20 and the valves 21 and 22 are integrally rotated to open or close the fluid passages 11 and 12. In order to suppress rattling of the shaft 20 due to vibration, fluid force, and so on, as well as to return the shaft 20 to a prescribed rotational position when the actuator 30 is in failure, a spring 33 is placed between the housing 10 and the shaft 20.

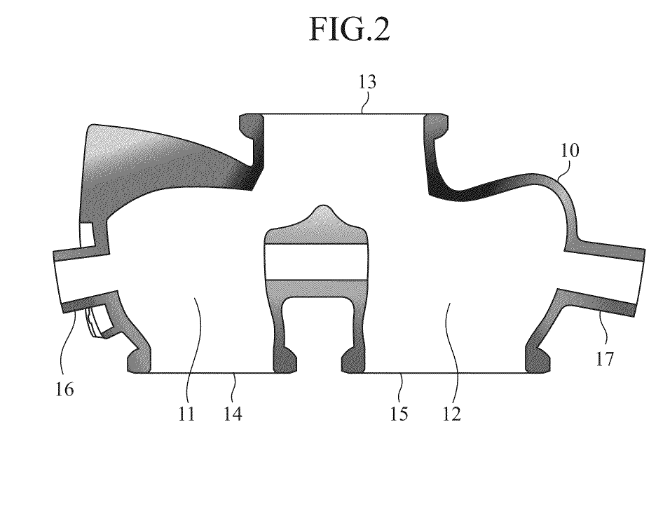

FIG. 2 is a cross-sectional view showing an example of thermal deformation of the housing 10, and highly stressed regions are shown in a dark color. In a state where the fluid inlet 13 and fluid outlets 14 and 15 are fixed to piping (not shown), when a high temperature gas flows from the fluid inlet 13 to the fluid outlets 14 and 15, the housing 10 expands and concentrates the stress around the fluid inlet 13, resulting in distorting largely. As a result, the distortion of the expansion due to a linear expansion thereof is asymmetric about the shaft 20 between the upstream side (fluid inlet 13 side) and the downstream side (fluid outlets 14, 15 side), so that there occurs deviation of coaxiality between the bearing holding parts 16 and 17.

In addition, when the high temperature gas continues to flow only one of the fluid passages 11 and 12, a temperature distribution is generated in the housing 10, and the deviation of coaxiality due to the distortion is further worsened.

Accordingly, in order to avoid adhesion or deterioration of slidability between the bearings 18 and 19 and the shaft 20 in cases where the deviation of coaxiality between the bearing holding parts 16 and 17 in machining the housing 10, and where there occurs the deviation of coaxiality due to the aforementioned expansion, it is necessary to enlarge a clearance between the shaft 20 and the bearings 18 and 19. However, when the clearance is enlarged, leakage from this clearance is increased; thus, a simple enlargement thereof is unfavorable.

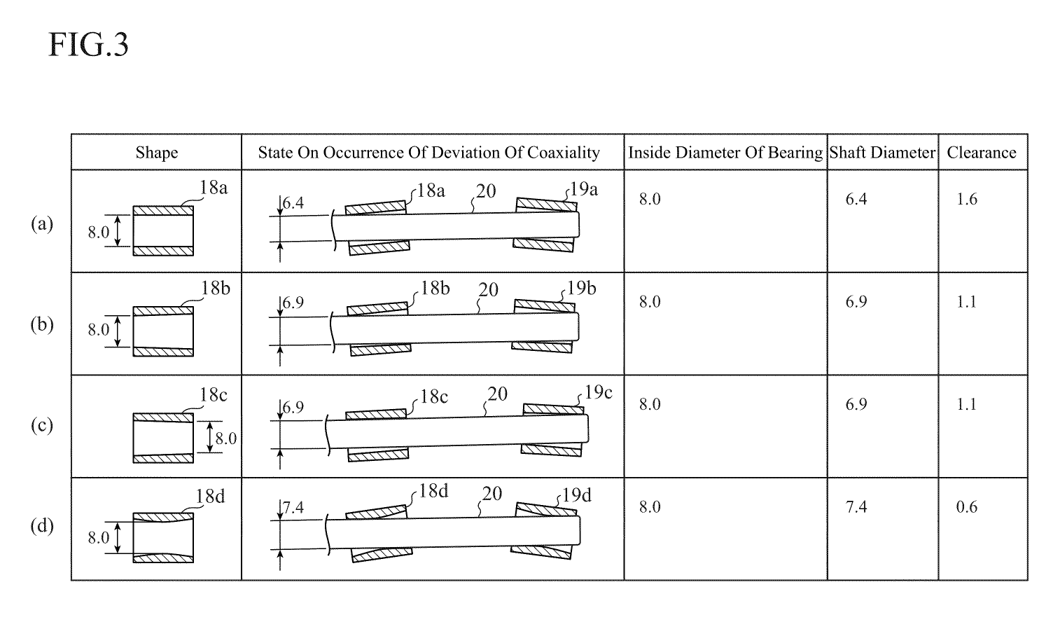

A bearing 18a shown in FIG. 3(a) is a cylinder and has an inside diameter of 8.0 mm (all units are given by “mm”). When there occurs the deviation of coaxiality between the bearing holding parts 16 and 17 (not shown), it is estimated that the maximum outer diameter of the shaft 20 without the adhesion and deterioration of slidability is 6.4. Therefore, a clearance in a normal condition between the shaft 20 and the bearings 18a and 19a needs to be at least 1.6 in order to avoid the adhesion and deterioration of slidability.

On the other hand, bearings 18b and 19b shown in FIG. 3(b) each are a cylinder that has an inside diameter of 8.0 on the side away from the fluid passages 11 and 12, and such that the inside diameter gradually increases as approaching the fluid passages 11 and 12. In the case of using these bearings 18b and 19b, even when there occurs the deviation of coaxiality that is equal to that of FIG. 3(a), it is estimated that the maximum outer diameter of the shaft 20 in which the adhesion and deterioration of slidability do not occur is 6.9, and thus the clearance can be set as small as 1.1. Therefore, shaft leakage can be suppressed as compared to the case shown in FIG. 3(a).

In addition, bearings 18c and 19c shown in FIG. 3(c) each are a cylinder that has an inside diameter of 8.0 on the side closer to the fluid passages 11 and 12, and such that the inside diameter gradually increases as being away from the fluid passages 11 and 12. In the case of using these bearings 18c and 19c, even when there occurs the deviation of coaxiality that is equal to that of FIG. 3(a), it is estimated that the maximum outer diameter of the shaft 20 in which the adhesion and deterioration of slidability do not occur is 6.9, and thus the clearance can be set as small as 1.1. Therefore, the shaft leakage can be suppressed as compared to the case shown in FIG. 3(a).

Also, with the shape of the bearings 18c and 19c, the clearance between the shaft 20 and the bearings can be made smaller on the side closer to the fluid passage 11 or 12 when there occurs the deviation of coaxiality; thus, the seat leakage that occurs through the clearance when the valve 21 or 22 is completely closed can also be suppressed.

Further, the bearings 18d and 19d shown in FIG. 3(d) each are a cylinder that has an inside diameter of 8.0 at the center portion in an axial direction thereof, and such that the inside diameter gradually increases toward two ends thereof. In the case of using these bearings 18d and 19d, even when there occurs the deviation of coaxiality that is equal to that of FIG. 3(a), it is estimated that the maximum outer diameter of the shaft 20 in which the adhesion and deterioration of slidability do not occur is 7.4, and thus the clearance can be set as small as 0.6. Therefore, the shaft leakage can be suppressed as compared to not only the design shown in FIG. 3(a) but also the cases shown in FIG. 3(b) and FIG. 3(c).

Also, with the shape of these bearings 18d and 19d, there is no restriction on the orientation of the bearings when mounted in the bearing holding parts 16 and 17, so that the assembling work is facilitated.

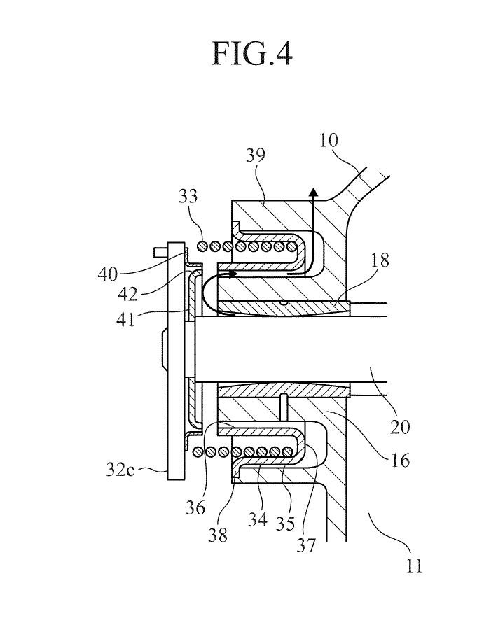

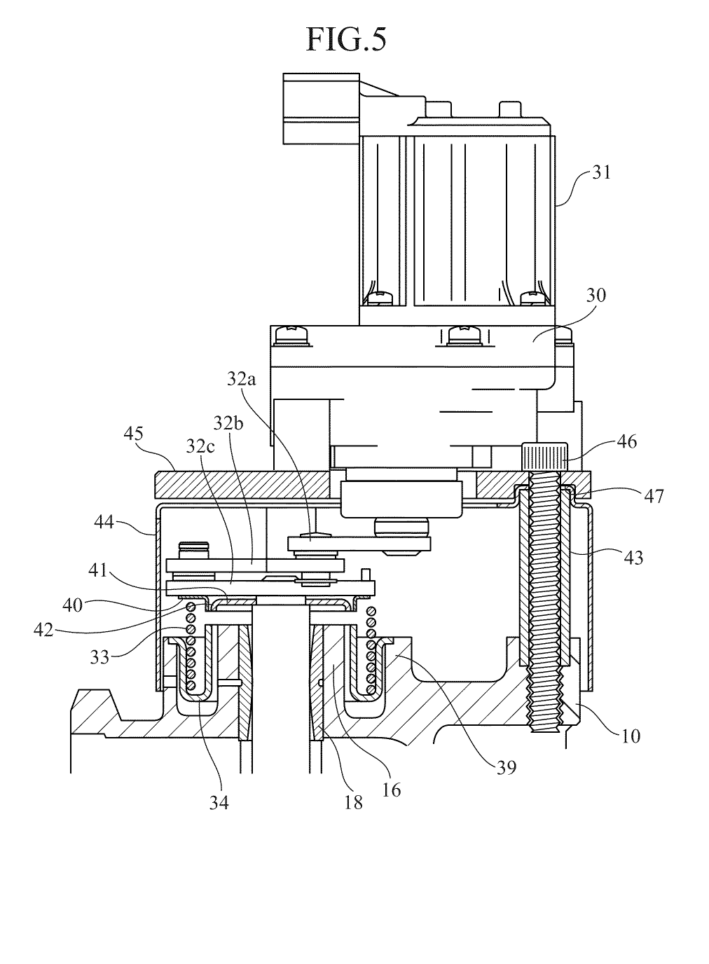

It is noted that in FIG. 3 simulated results under conditions with larger numerical values are shown so as to clearly illustrate an effect on the clearance by a difference in the inner shape of the bearings. Similarly, in FIG. 1, and even in FIG. 4 and FIG. 5 illustrated below, the inner circumferential shape of the bearings 18 and 19 is illustrated in an exaggerated manner rather than the actual shape. Incidentally, the bearings 18 and 19 in FIG. 1 have the same shape as that of the bearings 18d and 19d in FIG. 3(d), and an actual clearance between the bearings and the shaft 20 is about several μm.

FIG. 4 is an enlarged cross-sectional view of a spring 33 and its peripheral structure.

Since the housing 10 flowing the high temperature gas becomes high temperature, the spring 33 suffers heat deformation when it is set directly at the housing 10. However, the setting of the spring 33 away from the housing 10 increases the total length of the butterfly valve.

Thus, without setting directly the spring 33 at the housing 10, a spring holder 34 is set at the housing 10, and the spring 33 is set at the spring holder 34 to thus reduce the influence caused by the high heat.

The spring holder 34 is composed of an outer cylinder part 35 covering the outer side of the spring 33, an inner cylinder part 36 covering the inner side of the spring 33, a bottom part 37 closing a gap between the outer cylinder part 35 and inner cylinder part 36 on the side nearer the fluid passage 11, and a holder fixing part 38 that fixes the outer cylinder part 35 to the housing 10.

On the other hand, a projection 39 is formed at the outer periphery of the bearing holding part 16 of the housing 10. Then, the spring holder 34 is arranged between the bearing holding part 16 and the projection 39, and the holder fixing part 38 is fixed to the projection 39. At this time, in order to suppress the influence of the heat from the housing 10, it is desirable that the spring holder 34 should be fixed to the housing 1 by forming the holder fixing part 38 at the remotest position from the fluid passage 11, namely at the end on the open side of the inner cylinder part 36 and outer cylinder part 35.

Since the portions of the spring holder 34 except the holder fixing part 38 are put in a state separated from the housing 10 (bearing holding part 16 and projection 39), the heat of the high temperature gas flowing in the fluid passage 11 is not directly conducted from the housing 10 thereto. Moreover, when the inner cylinder part 36 is further extended in the axial direction, the heat conducted from the bearing holding part 16 to the spring 33 can be suppressed.

When a torsion spring part of the spring 33 is twisted, it is fallen; thus, the inner cylinder part 36 comes in contact with the inside of the torsion spring part, which serves as a fall-preventive guide. This spring holder 34 is a part that retains a hook (not shown) on the fixing side of the spring 33, and does not wear much by a relative displacement with the spring 33. The other hook (not shown) of the spring 33 is held by a power transmission member 32c, so that an urging force of the spring 33 is transmitted to the shaft 20 via the power transmission member 32c.

In addition, two components, guide members 40 and 41, are provided as the fall-preventive guide on the side of the upper end of the torsion spring part of the spring 33. One guide member 40 is an annular member in sliding contact with the end of the spring 33, and mounted on the torsion spring part and subjected to the urging force in the axial direction to be thus put in a pressed state against the power transmission member 32c. The guide member 41 is fixed to the shaft 20 at the inner diameter; when the torsion spring part is fallen, the guide member 40 in sliding contact with this torsion spring part also radially moves together, and abuts on the guide member 41 to restrict a further movement of the guide member 40, thus preventing the falling.

Since these guide members 40 and 41 are provided as separate members, which provides a structure in which the guide member 40 coming in contact with the spring 33 is not directly attached to the shaft 20, the heat transmitted from the shaft 20 to the spring 33 is reduced.

Further, a rat guard portion 42 is provided at the peripheral part of the guide member 41. The rat guard portion 42 is a peripheral (circumferential) wall protruding from the peripheral part of the guide member 41 toward the fluid passage 11 side; when the high temperature gas shaft-leaking through the clearance between the shaft 20 and the bearing 18 is escaped to a direction not directly hitting on the guide member 40 and the spring 33 (direction indicated by an arrow in FIG. 4), thereby suppressing also deformation of the spring 33 due to the leakage gas. The leakage gas guided by the rat guard portion 42 passes through a gap between the bearing holding part 16 and the spring holder 34 to be exhausted to the outside.

Additionally, though the rat guard portion 42 is formed at the guide member 41 in the illustrated example, it may be formed at the guide member 40.

FIG. 5 is an enlarged cross-sectional view of the power transmission member 32c and its peripheral structure.

Since the actuator 30 having the motor 31 has low heat resistance, heat transfer from the housing 10 should be reduced as much as possible. Thus, the actuator 30 is not directly mounted on the housing 10, but is mounted thereon via an insulation member 43. In the example of FIG. 5, for example, a stainless steel pipe with low heat conductivity is used as the insulation member 43, and attached thereto such that only both ends of the pipe come in contact with the housing 10 and a base plate 45. In this way, the actuator 30 can be mounted thereon away from the housing 10, and also heat transfer from the housing 10 to the actuator 30 can be reduced.

Further, a surface of the housing 10 opposite the actuator 30 is covered by a cover 44 so as to block radiation heat from the housing 10 and the leakage gas. The cover 44 may be made of a material with high heat conductivity to enhance heat dissipation thereof. In the example of FIG. 5, the cover 44 and the base plate 45 of the actuator 30 each have a hole to be inserted through by a bolt 46, and the housing 10 has a screw hole for fastening the bolt 46. Furthermore, a raised abutment portion 47 is formed around the hole in the cover 44, resulting in a state such that only this abutment portion 47 comes in contact with the base plate 45, and that the other portions are separated from the base plate 45. In this manner, a gap is created between the cover 44 and the base plate 45, so that the heat transfer from the cover 44 to the base plate 45 on which the actuator 30 is mounted can be reduced.

As described above, according to Embodiment 1, the butterfly valve includes: the housing 10 provided with fluid passages 11 and 12; the bearings 18 and 19 at two opposite positions of the housing 10 interposing the fluid passages 11 and 12; the shaft 20 rotatably held by the bearings 18 and 19; and the valves 21 and 22 that open or close the fluid passages 11 and 12 by rotating integrally with fixed to the shaft 20, and it is configured such that an inside diameter of the bearings 18 and 19 has a shape to gradually extend along the axial direction of the shaft 20. Therefore, while the deterioration of slidability and adhesion on the shaft 20 are avoided when there occurs the deviation of coaxiality in the bearings 18 and 19, an increase of the fluid leakage can be suppressed.

In particular, when the bearings 18 and 19 have the shape gradually extending along the axial direction of the shaft 20 (bearings 18c and 19c) such that the inside diameter on the side closer to the fluid passages 11 and 12 is smaller, while the inside on the side farther therefrom is larger, in addition to the above effect, there is also an advantageous effect of reducing the seat leakage from the upstream side to the downstream side through a clearance between the shaft 20 and the bearings 18 and 19 when the valve 21 or 22 is fully closed.

Also, when the bearings 18 and 19 have the shape gradually extending along the axial direction of the shaft 20 such that the inside diameter at the center portion thereof is smaller, while the inside diameter at both ends thereof is larger (bearings 18d and 19d), in addition to the above effects, there is also an advantageous effect of facilitating the assembling work.

Also, according to the above Embodiment 1, the butterfly valve includes: the annular guide member 40 in sliding contact with the end of the spring 33 that is installed around the outer circumference of the shaft 20; and the guide member 41 fixed to the shaft 20 on an inner side of the guide member 40 and having an outer circumferential part thereof to restrict a radial movement of the guide member 40 by abutting on an inner circumferential part of the guide member 40, and it is configured such that the rat guard portion 42 is formed in the outer circumferential part of the guide member 41. Therefore, the heat transfer from the shaft 20 can be reduced while suppressing the falling of the spring 33. In addition, since the high temperature gas leaking from the bearing 18 can be escaped to a direction not directly hitting on the spring 33 by virtue of the rat guard portion 42, the heat deformation of the spring 33 can be suppressed.

Also, according to the above Embodiment 1, the butterfly valve is installed with the spring holder 34 that houses the spring 33 around a hole in the housing 10 penetrated by the end of the shaft 20, and this spring holder 34 is configured with: the inner cylinder part 36 covering the inner side of the spring 33; the outer cylinder part 35 covering the outer side of the spring; and the bottom part 37 closing the gap between the inner cylinder part 36 and outer cylinder part 35, and it is configured to be fixed to the projection 39 of the housing 10 at the holder fixing part 38 on the open end side of the inner cylinder part 36 and the outer cylinder part 35 with the other portions separated from the housing 10. Therefore, the heat transferring from the housing 10 to the spring 33 can be reduced.

Also, according to the above Embodiment 1, the butterfly valve is configured to include: the actuator 30 that rotates and drives the shaft 20; and the insulation member 43 provided between the actuator 30 and the housing 10, and holding the actuator 30 in a state separated from the housing 10. Therefore, the heat transfer to the actuator 30 with low heat resistance can be minimized.

Also, according to Embodiment 1, since the butterfly valve is configured to include the cover 44 that covers the surface of the housing 10 opposite the actuator 30, the radiation heat from the housing 10 and the leakage gas can be blocked to thus protect the actuator 30 with low heat resistance.

Also, according to Embodiment 1, since the butterfly valve is configured such that a gap is formed between the base plate 45 on which the actuator 30 is mounted and the cover 44, the heat transfer from the cover 44 to the actuator 30 can be reduced.

It should be noted that within the scope of the present invention, any component in the embodiment may be modified, or any component in the embodiment may be omitted.

For example, in the above Embodiment 1, there is illustrated the example in which the present invention is applied to the butterfly valve configured to open or close a bifurcated fluid passage with the two valves fixed to the shaft; however, it may be applied to a butterfly valve configured to open or close a single fluid passage with a single valve. Note that since the deviation of coaxiality tends to occur in a case where the housing has a shape asymmetric between the upstream and downstream sides, even when the butterfly valve is provided with the single butterfly valve and the single fluid passage, the effects of the invention will be more evident if the passage has an asymmetric housing. Additionally, since the deviation of coaxiality between the bearings tends to be larger as the shaft is longer, the present invention will be more evident if there are more valves (namely if the shaft is longer).

### INDUSTRIAL APPLICABILITY

As described above, since the butterfly valve according to the present invention is less affected by high temperatures, it is suitable for use in an EGR valve or the like for circulation of exhaust gas of a high temperature (500° C. to 800° C.)

### EXPLANATION OF REFERENCE NUMERALS

10: housing
11, 12: fluid passage
13: fluid inlet
14, 15: fluid outlet
16, 17: bearing holding part
18, 19: bearing
20: shaft
21, 22: valve
30: actuator
31: motor
32a to 32c: power transmission member
33: spring
34: spring holder
35: outer cylinder part
36: inner cylinder part
37: bottom
38: holder fixing part
39: projection
40, 41: guide member
42: rat guard (peripheral wall)
43: insulation member
44: cover
45: base plate
46: bolt
47: abutment portion.

1-10. (canceled)

11. A butterfly valve comprising:
a housing provided with a fluid passage;
bearings at two places each provided at opposite positions of the housing interposing the fluid passage;
a shaft rotatably held by the bearings at the two places; and
a valve that opens and closes the fluid passage by rotating integrally with fixed to the shaft, wherein
an inside diameter of the bearing has a shape to gradually extend toward two ends of the bearing.

12. The butterfly valve according to claim 11, wherein the housing has a shape that is asymmetric about the shaft between upstream and downstream sides.

13. The butterfly valve according to claim 11, further comprising an annular first guide member in sliding contact with an end of a spring that is installed around an outer circumference of the shaft, and
a second guide member fixed to the shaft on an inner side of the first guide member and having an outer circumferential part to restrict a radial movement of the first guide member by abutting on an inner circumferential part of the first guide member, wherein
one of the first guide member and the second guide member is formed with a peripheral wall in its peripheral part.

14. The butterfly valve according to claim 11, wherein a spring holder that houses a spring is installed around a hole in the housing penetrated by an end of the shaft, wherein
the spring holder is configured with: an inner cylinder part that covers an inner side of the spring; an outer cylinder part that covers an outer side of the spring; and a bottom part that closes a gap between the inner cylinder part and the outer cylinder part on the housing side, the holder being fixed to the housing at an open end side of the inner cylinder part and the outer cylinder part with the other portions separated from the housing.

15. The butterfly valve according to claim 11, further comprising an actuator that rotates and drives the shaft, and
an insulation member that is provided between the actuator and the housing, and holds the actuator in a state separated from the housing.

16. The butterfly valve according to claim 15, further comprising a cover that covers a surface of the housing opposite the actuator.

17. The butterfly valve according to claim 16, wherein a gap is provided between the actuator and the cover.

18. The butterfly valve according to claim 12, wherein two valves fixed to the shaft open or close a bifurcated fluid passage.
